(19) United States
(12) Patent Application Publication
(10) Pub. No.: US 2026/0100365 A1
(43) Pub. Date: Apr. 9, 2026

(54) ANODE ACTIVE MATERIAL FOR RECHARGEABLE LITHIUM BATTERY COMPRISING CALCIUM SILICATE, METHOD FOR PREPARING THE SAME, AND RECHARGEABLE LITHIUM BATTERY COMPRISING THE SAME

(71) Applicants: Hyundai Motor Company, Seoul (KR); Kia Corporation, Seoul (KR); IUCF-HYU (Industry-University Cooperation Foundation Hanyang University, Seoul (KR)

(72) Inventors: Seung Tae Kim, Hwaseong (KR); Sung Ho Ban, Hwaseong (KR); Sanghun Lee, Hwaseong (KR); Changhoon Song, Hwaseong (KR); Taeho Park, Hwaseong (KR); Kikang Lee, Hwaseong (KR); Namgyu Kim, Hwaseong (KR); Seung-Min Oh, Hwaseong (KR); Eungju Lee, Hwaseong (KR); Donghan Youn, Namyangju (KR); Hansu Kim, Seoul (KR)

(21) Appl. No.: 19/050,908

(22) Filed: Feb. 11, 2025

(30) Foreign Application Priority Data
Oct. 8, 2024 (KR) 10-2024-0136346

(51) Int. Cl. H01M 4/58; C01F 11/12; H01M 4/02; H01M 4/36

(52) U.S. Cl. CPC H01M 4/5825; C01F 11/12; H01M 4/366; C01P 2002/72; C01P 2002/82; C01P 2004/03; C01P 2006/40; H01M 2004/021; H01M 2004/027

(57) ABSTRACT

The present disclosure relates to an anode active material for a rechargeable lithium battery including calcium silicate, a method for preparing the same, and a rechargeable lithium battery including the same. According to the present disclosure, it is possible to improve the initial efficiency of a rechargeable lithium battery by providing an anode active material for the rechargeable lithium battery that does not react with lithium and to provide a rechargeable lithium battery with improved charge/discharge life characteristics by increasing the sizes of internal pores.

### CROSS-REFERENCE TO RELATED APPLICATION

This present application claims the benefit of priority to Korean Patent Application No. 10-2024-0136346, entitled “ANODE ACTIVE MATERIAL COMPRISING CALCIUM SILICATE, METHOD FOR PREPARING THE SAME, AND RECHARGEABLE LITHIUM BATTERY COMPRISING THE SAME,” filed on Oct. 8, 2024, in the Korean Intellectual Property Office, the entire disclosure of which is incorporated herein by reference.

### FIELD

The present disclosure relates to an anode active material for a rechargeable lithium battery including calcium silicate, a method for preparing the same, and a rechargeable lithium battery including the same.

### BACKGROUND

Rechargeable lithium batteries are widely used in a wide range of applications, from small electronic devices such as smartphones to medium and large energy storage devices such as batteries for electric vehicles. Recently, the demand for high-energy density batteries has been increased as a countermeasure to global regulations such as CO₂ and greenhouse gas emission regulations.

Graphite, which is generally used as an anode of the rechargeable lithium battery, has a low theoretical capacity per weight of 372 mAh/g, which has a limitation in energy density, and thus various materials capable of overcoming the limitation have been studied. Among them, silicon has a discharge capacity per weight that is about 10 times higher than that of graphite of 3579 mAh/g, and thus is attracting attention as a next-generation anode active material. However, the silicon has a disadvantage of poor life characteristics due to particle fragmentation and electrode detachment due to a high expansion rate (˜300%) during a single charge. In addition, silicon oxide SiOₓ (0<x<2) has a discharge capacity per weight that is about 3 times higher than that of graphite, and has excellent life characteristics compared to silicon. However, there is a problem that the silicon oxide shows low initial efficiency due to an irreversible reaction that occurs during an initial charging process.

In the case of lithium consumed through the irreversible reaction, the energy density is directly reduced in the full cell operation where the total amount of lithium is fixed, so that a technology to alleviating the reduction is required. Research has been conducted on using silicon oxide as an anode material for a rechargeable lithium battery by reacting with other metal materials such as Li (prelithiation), Mg, and Ca to form a complex, as a method for increasing the initial efficiency of such materials.

However, the materials used to form the complex are highly reactive like lithium metal, and react in the air and the homogeneity of the obtained anode material is lowered through a violent reaction, or the synthesized material is vulnerable to moisture and oxygen in the air, and thus has low reliability and increases the cost of the process.

### SUMMARY

An aspect of the present disclosure is to provide an anode active material for a rechargeable lithium battery including an irreversible phase that does not react with lithium.

Another aspect of the present disclosure is to provide a method for preparing an anode active material for a rechargeable lithium battery capable of increasing the size of internal pores.

An aspect of the present disclosure is to provide an anode active material that may be applied to a green technology field using a battery, such as electric vehicles.

In order to achieve the aspect, the present disclosure provides an anode active material for a rechargeable lithium battery including calcium silicate represented by CaₓSi_{y}O_{z} (1≤x≤3, 1≤y≤3, 3≤z≤9), and crystalline silicon.

According to an example of the present disclosure, the calcium silicate may comprise at least one selected from the group consisting of CaSiO₃, Ca₃Si₃O₉, and Ca₂SiO₄.

In the anode active material for the rechargeable lithium battery according to an example of the present disclosure, a pore volume measured by a BJH method may be 5 cm³/kg to 30 cm³/kg.

In the anode active material for the rechargeable lithium battery according to an example of the present disclosure, the calcium silicate and the crystalline silicon may be comprised in a weight ratio of 1:0.5 to 1:1.5.

According to an example of the present disclosure, the calcium silicate may comprise CaSiO₃ and Ca₃Si₃O₉ in a weight ratio of 1:0.1 to 1:1.

According to an example of the present disclosure, the anode active material for the rechargeable lithium battery may comprise crystalline silicon, CaSiO₃, and Ca₃Si₃O₉, and based on 100 parts by weight of the anode active material for the rechargeable lithium battery, the crystalline silicon may be comprised in an amount of 40 to 55 parts by weight, the CaSiO₃ may be comprised in an amount of 30 to 40 parts by weight, and the Ca₃Si₃O₉ may be comprised in an amount of 10 to 20 parts by weight.

According to an example of the present disclosure, the anode active material for the rechargeable lithium battery may comprise a composite combined with calcium silicate and crystalline silicon; and a carbon coating formed on at least a portion of the surface of the composite.

According to an example of the present disclosure, the anode active material may have a core-shell structure including a core comprising a composite combined with calcium silicate and crystalline silicon and a shell including carbon.

According to an example of the present disclosure, the thickness of the carbon coating may be 0.1 nm to 10 nm.

Another aspect of the present disclosure provides a method for preparing an anode active material for a rechargeable lithium battery, including a) mixing silicon monoxide (SiO) and calcium hydride (CaH₂) to prepare mixed powder; and b) heat-treating the mixed powder to obtain a heat-treated product.

According to an example of the present disclosure, the mixed powder may have a molar ratio (Ca/Si) of calcium to silicon of 0.1 to 1.

According to an example of the present disclosure, the heat treatment may be performed at 800° C. to 1300° C.

According to an example of the present disclosure, the method for preparing the anode active material for the rechargeable lithium battery may further comprise c) pulverizing the heat-treated product; and d) carbon-coating the heat-treated product pulverized in the pulverizing step.

According to an example of the present disclosure, the pulverization may be performed by a ball mill method.

According to an example of the present disclosure, the ball mill method may have a Ball-to-Powder weight Ratio (BPR) of 5:1 to 50:1 and may be performed for 10 hours to 36 hours.

The carbon coating may be performed under an argon (Ar) gas atmosphere at 350° C. to 1200° C. for 0.5 to 10 hours.

In addition, yet another aspect of the present disclosure provides an anode for a rechargeable lithium battery, including the anode active material for the rechargeable lithium battery.

In addition, yet another aspect of the present disclosure provides a rechargeable lithium battery, including the anode for the rechargeable lithium battery; a cathode; a separator positioned between the anode and the cathode; and an electrolyte.

According to one example of the present disclosure, it is possible to improve the initial efficiency of a rechargeable lithium battery.

According to another aspect of the present disclosure, it is possible to improve the charge/discharge life characteristics of the rechargeable lithium battery.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating X-ray diffraction (XRD) analysis results for anode active materials according to Examples 1 to 3 of the present disclosure;

FIG. 2 is a diagram illustrating XRD analysis results for anode active materials according to Example 4 of the present disclosure and Comparative Example 2;

FIG. 3 is a diagram illustrating XRD analysis results for anode active materials according to Examples of the present disclosure to confirm the influence of Ca/Si molar ratio;

FIG. 4 is a diagram illustrating XRD analysis results for anode active materials according to Examples of the present disclosure to confirm the influence of heat-treatment temperature;

FIG. 5 is a diagram illustrating Raman spectroscopy measurement results for anode active materials according to Examples of the present disclosure and Comparative Example;

FIG. 6 is a diagram illustrating a 29Si-MAS-NMR analysis result for an anode active material according to Example 1 of the present disclosure;

FIG. 7 is a diagram illustrating a FIB-SEM analysis result for an anode active material according to Example 4 of the present disclosure;

FIG. 8 is a diagram illustrating results of evaluating the initial efficiency of cells including anode active materials according to Examples 1 to 3 of the present disclosure and Comparative Example 1;

FIG. 9 is a diagram illustrating results of evaluating the discharge capacity of cells including anode active materials according to Examples 1 to 3 of the present disclosure and Comparative Example 1;

FIG. 10 is a diagram illustrating results of evaluating the initial efficiency and discharge capacity of cells including anode active materials according to Examples 1 and 4 of the present disclosure and Comparative Example 2;

FIG. 11 is a diagram illustrating results of evaluating the life characteristics of cells including anode active materials according to Examples 1 and 4 of the present disclosure and Comparative Example 2;

FIG. 12 is a diagram illustrating results of evaluating the discharge capacity of cells including anode active materials according to Examples of the present disclosure to confirm the influence of Ca/Si molar ratio;

FIG. 13 is a diagram illustrating results of evaluating the life characteristics of cells including anode active materials according to Examples of the present disclosure to confirm the influence of Ca/Si molar ratio;

FIG. 14 is a diagram illustrating STEM-EDS analysis results for anode active materials according to Examples 1 to 3 of the present disclosure;

FIG. 15 is a diagram illustrating STEM-EDS analysis results for anode active materials according to Example 4 of the present disclosure and Comparative Example 2; and

FIG. 16 is a diagram illustrating a HR-TEM analysis result for an anode active material according to Example 4 of the present disclosure.

### DETAILED DESCRIPTION

Hereinafter, the present disclosure will be described in more detail. However, the following examples or embodiments are only a reference for explaining the present disclosure in detail, and the present disclosure is not limited thereto, and may be implemented in various forms.

Further, unless otherwise defined, all technical and scientific terms have the same meaning as commonly understood by those skilled in the art to which the present disclosure pertains.

The terminology used in the description herein is merely to effectively describe specific embodiments and is not intended to limit the present disclosure.

In addition, as used in the specification and the appended claims, the singular forms may be intended to comprise plural forms, unless clearly dictated in the contexts otherwise.

In addition, units used in this specification without special mention are based on weight, and for example, units of % or ratio mean wt % or weight ratio, and wt % means wt % of any one component in the entire composition, unless otherwise defined.

Further, unless explicitly described to the contrary, when any part “comprises” any component, it will be understood to further comprise other components rather than excluding other components.

In addition, the numerical ranges used in the present disclosure may comprise lower and upper limits and all values within that range, increments logically derived from the shape and width of the defined range, all doubly defined values, and all possible combinations of upper and lower limits of numerical ranges defined in different shapes. Unless otherwise specifically defined in the specification of the present disclosure, values out of the numerical range that may arise due to experimental error or rounding of values are also comprised in the defined numerical range.

Hereinafter, the present disclosure will be described in more detail.

The present disclosure relates to an anode active material for a rechargeable lithium battery including calcium silicate and crystalline silicon, a method for preparing the same, and a rechargeable lithium battery including the same. The anode active material for the rechargeable lithium battery of the present disclosure may comprise an irreversible phase that does not react with lithium ions to suppress a phenomenon in which the initial efficiency of the rechargeable lithium battery is lowered. In addition, the anode active material comprises internal pores to improve the life characteristics of the battery.

The present disclosure provides an anode active material for a rechargeable lithium battery including calcium silicate represented by CaₓSi_{y}O_{z} (1≤x≤3, 1≤y≤3, 3≤z≤9); and crystalline silicon.

In one example of the present disclosure, the calcium silicate may comprise at least one selected from the group consisting of CaSiO₃, Ca₃Si₃O₉, and Ca₂SiO₄, and specifically, CaSiO₃, Ca₃Si₃O₉, or a combination thereof. In particular, CaSiO₃ and Ca₃Si₃O₉ are irreversible phases that do not react with lithium ions, and thus may improve the initial efficiency of a battery using an anode active material including the same.

In one example of the present disclosure, the anode active material for the rechargeable lithium battery may have a pore volume measured by a Barrett-Joyner-Halenda (BJH) method of 5 cm³/kg to 30 cm³/kg, specifically 7 cm³/kg to 25 cm³/kg, more specifically 10 cm³/kg to 20 cm³/kg, and most specifically 13 cm³/kg to 18 cm³/kg. When the range is satisfied, the life characteristics of the rechargeable lithium battery may be improved. That is, through the pore volume in the range, the volume expansion of silicon may be offset during charging, thereby suppressing the volume change according to charge and discharge.

When the anode active material for the rechargeable lithium battery of the present disclosure comprises the crystalline silicon, the crystalline silicon has a high theoretical capacity, thereby implementing a high energy density battery. In addition, the crystalline silicon has excellent electrical conductivity to enable rapid charge and discharge of the battery.

In one example of the present disclosure, the anode active material for the rechargeable lithium battery may comprise the calcium silicate and the crystalline silicon in a weight ratio of 1:0.5 to 1:1.5, specifically a weight ratio of 1:0.8 to 1:1.2, but is not limited thereto.

In one example of the present disclosure, the calcium silicate may comprise CaSiO₃ and Ca₃Si₃O₉ in a weight ratio of 1:0.1 to 1:1, specifically a weight ratio of 1:0.3 to 1: 0.8, and more specifically a weight ratio of 1:0.4 to 1:0.5, but is not limited thereto as long as the purpose of the present disclosure may be achieved.

In one example of the present disclosure, the anode active material for the rechargeable lithium battery may comprise crystalline silicon, CaSiO₃, and Ca₃Si₃O₉. Based on 100 parts by weight of the anode active material for the rechargeable lithium battery, the crystalline silicon may be comprised in an amount of 40 to 55 parts by weight, the CaSiO₃ may be comprised in an amount of 30 to 40 parts by weight, and the Ca₃Si₃O₉ may be comprised in an amount of 10 to 20 parts by weight. Specifically, based on 100 parts by weight of the anode active material for the rechargeable lithium battery, the crystalline silicon may be comprised in an amount of 45 to 50 parts by weight, the CaSiO₃ may be comprised in an amount of 32 to 38 parts by weight, and the Ca₃Si₃O₉ may be comprised in an amount of 12 to 18 parts by weight, but it is not limited thereto as long as the purpose of the present disclosure may be achieved.

In one example of the present disclosure, the anode active material for the rechargeable lithium battery may comprise a composite combined with calcium silicate and crystalline silicon; and a carbon coating formed on at least a portion of the surface of the composite. Specifically, the anode active material may have a core-shell structure including a core comprising a composite combined with calcium silicate and crystalline silicon and a shell including carbon. In one example of the present disclosure, the thickness of the carbon coating may be 0.1 nm to 10 nm, specifically 1 nm to 5 nm, and more specifically 2 nm to 3 nm, but is not limited thereto.

In addition, the present disclosure provides a method for preparing an anode active material for a rechargeable lithium battery, including a) mixing silicon monoxide (SiO) and calcium hydride (CaH₂) to prepare mixed powder; and b) heat-treating the mixed powder to obtain a heat-treated product.

In one example of the present disclosure, the mixed powder may have a molar ratio (Ca/Si) of calcium to silicon of 0.10 to 1, specifically 0.15 to 0.50, and more specifically 0.15 to 0.35. A battery including the anode active material prepared by satisfying the above range may exhibit excellent discharge capacity and life characteristics.

In one example of the present disclosure, the heat treatment may be performed at 800° C. to 1300° C., specifically 900° C. to 1200° C., and more specifically 1000° C. to 1100° C. When the range is satisfied, the coarsening of silicon particles may be suppressed, thereby preventing the deterioration of the life characteristics of the battery, and the generation of materials that may be deteriorated in the air.

In one example of the present disclosure, the method for preparing the anode active material for the rechargeable lithium battery may further comprise c) pulverizing the heat-treated product; and d) carbon-coating the heat-treated product pulverized in the pulverizing step. By further including step c), the internal pores may be formed larger, thereby improving the life characteristics of the battery. In addition, by further including step d), the life characteristics, electrochemical characteristics, and thermal stability of the battery may be improved.

In one example of the present disclosure, the pulverization may be performed by a ball mill, high-energy ball mill, attrition mill, jet mill, or resonance acoustic mixer method, and specifically, by a high-energy ball mill method, but is not limited thereto as long as the purpose of the present disclosure may be achieved.

In one example of the present disclosure, the ball mill method may have a Ball-to-Powder weight Ratio (BPR) of 5:1 to 50:1, and specifically 15:1 to 25:1. The ball mill method may be performed for 10 hours to 36 hours, and specifically, 20 hours to 30 hours. In addition, the ball mill method may be performed at a rotation speed of 50 rpm to 2000 rpm, and specifically, 100 rpm to 1000 rpm. However, the present disclosure is not limited thereto.

In one example of the present disclosure, the carbon coating may be performed under an argon (Ar) gas atmosphere at 350° C. to 1200° C., specifically 600° C. to 1000° C., for 0.5 to 10 hours, specifically 1 to 5 hours, but is not limited thereto.

Further, the present disclosure provides an anode for a rechargeable lithium battery, including the anode active material for the rechargeable lithium battery.

Since the description of the anode active material for the rechargeable lithium battery is the same as described above, it will be omitted.

In one example of the present disclosure, the anode for the rechargeable lithium battery may further comprise a binder, and the binder may be used without limitation as long as it is used in the art for manufacturing an anode for a rechargeable lithium battery.

In addition, the present disclosure provides a rechargeable lithium battery, including the anode for the rechargeable lithium battery; a cathode; a separator positioned between the anode and the cathode; and an electrolyte.

The cathode, the separator, and the electrolyte are not particularly limited in the present disclosure, and those known in the art may be adopted. Specific examples are as follows.

In one example of the present disclosure, the cathode may be manufactured by mixing and stirring a cathode active material with a solvent, if necessary, a binder, a conductive agent, a dispersant, etc., to prepare a mixture, and then applying the mixture to a current collector of a metal material, drying, and then pressing.

In one example of the present disclosure, the cathode active material may be an active material commonly used in the cathode of the rechargeable lithium battery. For example, the cathode active material may comprise lithium metal oxide particles including one or two or more metals selected from the group consisting of Ni, Co, Mn, Na, Mg, Ca, Ti, V, Cr, Cu, Zn, Ge, Sr, Ag, Ba, Zr, Nb, Mo, Al, Ga, B, and combinations thereof.

In one example of the present disclosure, a conventional conductive carbon material may be used as the conductive material without any particular limitation.

In one example of the present disclosure, the current collector of the metal material may be metal that has high conductivity and may be easily bonded with the mixture of the cathode active material, and may be used with any metal having no reactivity within the voltage range of the battery. Non-limiting examples of the cathode current collector may be selected from foils manufactured by aluminum, nickel, or a combination thereof.

In an example of the present disclosure, the separator is a separator formed with micropores through which ions may pass, and non-limiting examples thereof may be one or a combination of two or more selected from the group consisting of glass fiber, polyester, polyethylene, polypropylene, and polytetrafluoroethylene, and may be in the form of a non-woven fabric or woven fabric. Specifically, in the rechargeable lithium battery, a polyolefin polymer separator such as polyethylene and polypropylene may be mainly used, but is not limited thereto. In addition, a separator coated with a composition comprising a ceramic component or a polymer material may also be used to secure heat resistance or mechanical strength, and may selectively be used in a single-layer or multi-layer structure, and separators known in the art may be used, but are not limited thereto.

In an example of the present disclosure, the electrolyte may comprise organic liquid electrolytes, inorganic liquid electrolytes, solid polymer electrolytes, gel-type polymer electrolytes, solid inorganic electrolytes, and molten inorganic electrolytes that are usable in manufacturing the rechargeable lithium battery, but is not limited thereto.

In one example of the present disclosure, the electrolyte may comprise a non-aqueous organic solvent and a metal salt.

In one example of the present disclosure, examples of the non-aqueous organic solvent may be used with aprotic organic solvents, such as N-methyl-2-pyrrolidinone, propylene carbonate, ethylene carbonate, butylene carbonate, dimethyl carbonate, diethyl carbonate, gamma-butyrolactone, 1,2-dimethoxyethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphate triester, trimethoxymethane, dioxolane derivative, sulfolane, methyl sulfolane, 1,3-dimethyl-2-imidazolidinone, propylene carbonate derivatives, tetrahydrofuran derivatives, ether, methyl propionate, and ethyl propionate.

In one example of the present disclosure, among the carbonate-based organic solvents, ethylene carbonate and propylene carbonate, which are cyclic carbonates, are highly viscous organic solvents and may be preferably used due to a high dielectric constant to dissociate lithium salts well. When the cyclic carbonate is mixed and used with linear carbonate having low-viscosity and low-dielectric constant such as dimethyl carbonate and diethyl carbonate in an appropriate ratio, an electrolyte having high electrical conductivity may be prepared, which may be more preferably used.

In one example of the present disclosure, a lithium salt may be used as the metal salt, and the lithium salt is a material that is easily soluble in the non-aqueous electrolyte, and for example, anions of the lithium salt may be used with at least one selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SFs)₃C⁻, (CF₃SO₂)₃C⁻, CF₃(CF₂)₇SO₃⁻, CF₃CO₂⁻, CH₃CO₂⁻, SCN; and (CF₃CF₂SO₂)₂N⁻.

In one example of the present disclosure, in addition to the electrolyte components, the electrolyte may also further comprise one or more additives of, for example, haloalkylene carbonate-based compounds such as difluoroethylene carbonate, pyridine, triethyl phosphite, triethanolamine, cyclic ether, ethylene diamine, n-glyme, hexaphosphoric acid triamide, nitrobenzene derivatives, sulfur, quinone imine dye, N-substituted oxazolidinone, N,N-substituted imidazolidine, ethylene glycol dialkyl ether, ammonium salt, pyrrole, 2-methoxyethanol or aluminum trichloride, for the purpose of improving the life characteristics of the battery, suppressing reduction in battery capacity, improving a discharge capacity of the battery, and the like.

In one embodiment of the present disclosure, the appearance of the rechargeable lithium battery is not particularly limited, but may be selected from a cylindrical shape using a can, a square shape, a pouch shape, or a coin shape.

Hereinafter, preferable Examples of the present disclosure and Comparative Examples will be described. However, the following Examples are merely a preferred embodiment of the present disclosure, and the present disclosure is not limited to the following Examples.

### Example 1

5 g of SiO powder and 1.595 g of CaH₂ were added in a sealed container with zirconia balls (50 g) and mixed evenly so that a molar ratio (Ca/Si) of calcium to silicon was 0.33. Then, the prepared mixed powder was heat-treated at 1000° C. for 6 hours in an alumina crucible under an Ar atmosphere at a heating rate of 10° C./min to obtain a heat-treated product. The heat-treated product was pulverized in a mortar to obtain powder. In order to remove residual salts from the prepared powder, the prepared powder was stirred for 30 minutes using 500 ml of distilled water, filtered through a filter, and dried in a convection oven for one day to prepare an anode active material.

### Example 2

An anode active material was prepared in the same manner as in Example 1, except that the heat-treatment temperature was 1100° C.

### Example 3

An anode active material was prepared in the same manner as in Example 1, except that the heat-treatment temperature was 1200° C.

### Example 4

The anode active material prepared in the same manner as in Example 1 was pulverized for 27 hours using a high-energy ball milling method under BPR 20:1 (Big ball: Small ball=2:1) conditions. Thereafter, the pulverized anode active material was mixed with pitch carbon in a mortar in a mass ratio of 9:1, and the mixed powder was added in a beaker, mixed with a tetrahydrofuran (THF) solvent, and then stirred at 63° C. until the solvent was dried. The obtained powder was transferred to a mortar, pulverized, and then heat-treated at 800° C. for 2 hours under an argon gas atmosphere to prepare an anode active material comprising a calcium silicate-crystalline silicon composite with a carbon-coated surface.

### Example 5

An anode active material was prepared in the same manner as in Example 1, except that 5 g of SiO powder and 0.798 g of CaH₂ were used so that the molar ratio (Ca/Si) of calcium to silicon was 0.167.

### Example 6

An anode active material was prepared in the same manner as in Example 1, except that 5 g of SiO powder and 2.394 g of CaH₂ were used so that the molar ratio (Ca/Si) of calcium to silicon was 0.50.

### Example 7

An anode active material was prepared in the same manner as in Example 1, except that the heat-treatment temperature was 900° C.

### Example 8

An anode active material was prepared in the same manner as in Example 1, except that the heat-treatment temperature was 800° C.

### Comparative Example 1

SiO powder was used as an anode active material as it is without any separate treatment.

### Comparative Example 2

An anode active material comprising a calcium silicate-crystalline silicon composite with a carbon-coated surface was prepared by using a mixture in which 0.638 g of Si and 1.962 g of Ca₃Si₃O₉ were evenly mixed and performing ball milling and carbon coating under the same conditions as in Example 4.

### Experimental Example 1: X-Ray Diffraction Analysis

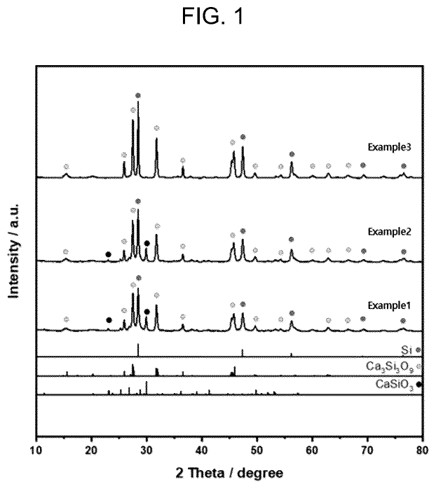

The anode active materials prepared according to Examples and Comparative Examples as described above were analyzed by X-ray diffraction, which were illustrated in FIGS. 1 to 4.

The specific X-ray diffraction analysis conditions were as follows.
i) Equipment: Bruker, D8 advance
ii) Condition: Cu Kα radiation (1.5418 Å)

FIG. 1 is a diagram illustrating X-ray diffraction (XRD) analysis results for anode active materials according to Examples 1 to 3 of the present disclosure.

Through FIG. 1, peaks of CaSiO₃ and Ca₃Si₃O₉ phases, which were Ca—Si—O-based phases, and peaks of Si phases reduced from SiO by a Ca—Si—O phase formation reaction were confirmed for Examples 1 to 3.

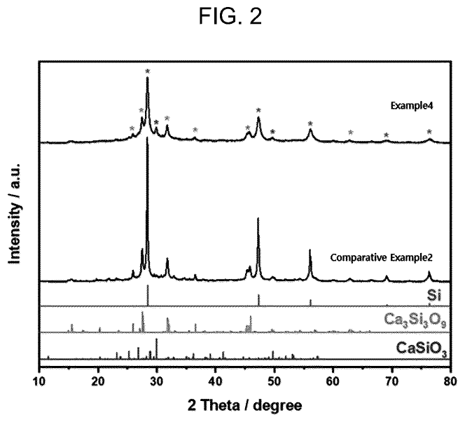

FIG. 2 is a diagram illustrating XRD analysis results for anode active materials according to Example 4 of the present disclosure and Comparative Example 2.

Through FIG. 2, it was confirmed that the peak intensities of the Si and Ca—Si—O phases of Example 4 decreased compared to those of Example 1, and the peak intensities of the Si and Ca—Si—O phases of Comparative Example 2 were stronger than those of Example 4.

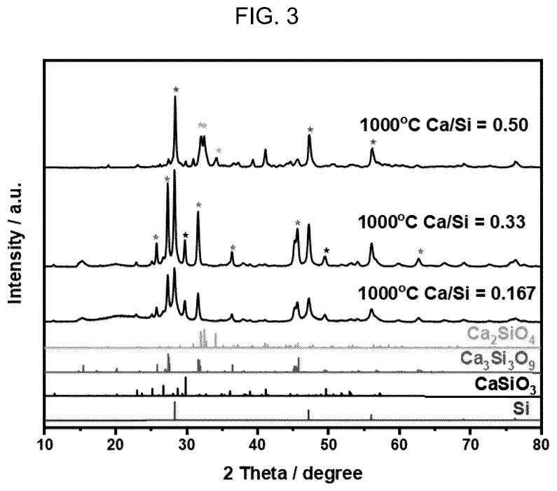

FIG. 3 is a diagram illustrating XRD analysis results for anode active materials according to Examples of the present disclosure to confirm the influence of Ca/Si molar ratio.

Through FIG. 3, it was confirmed that as the Ca/Si molar ratio increased, a Ca₂SiO₄ phase, which was a concern for deterioration in the air, was generated, and thus, a smaller Ca/Si molar ratio was relatively advantageous.

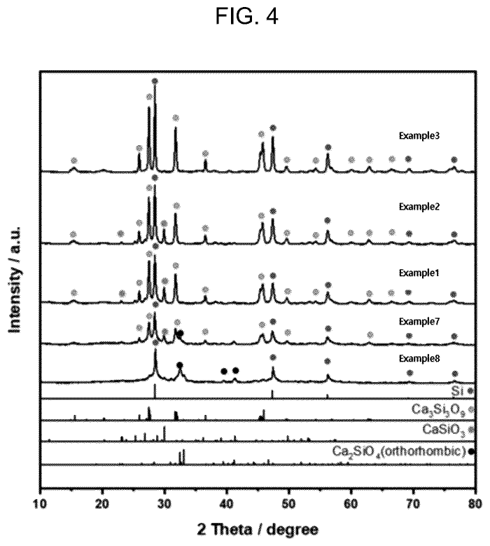

FIG. 4 is a diagram illustrating XRD analysis results for anode active materials according to Examples of the present disclosure to confirm the influence of heat-treatment temperature.

Through FIG. 4, it was confirmed that in the case of Examples 1 to 3 heat-treated at a temperature of 1000° C. or higher, a Ca₂SiO₄ phase, which was a concern for deterioration in the air, was not generated, and thus heat treatment at a temperature of 1000° C. or higher was relatively advantageous.

### Experimental Example 2: Raman Spectroscopy

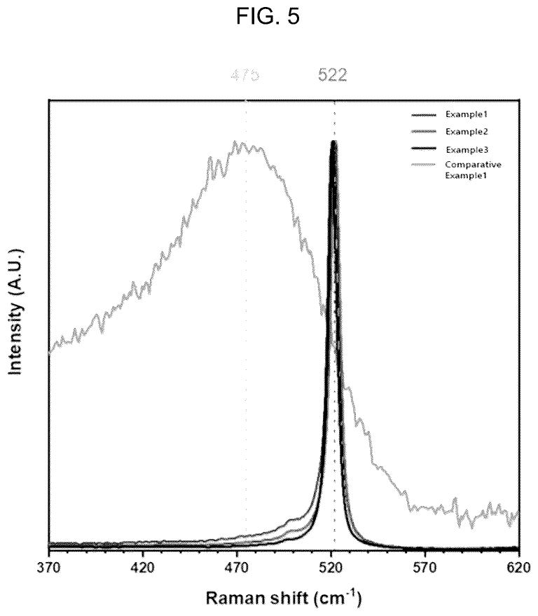

Raman spectra were measured using a 532 nm laser Raman analyzer for anode active materials prepared according to Examples and Comparative Examples, and the results were illustrated in FIG. 5.

The specific measurement conditions for the Raman spectra were as follows.
i) Equipment: DXR3xi, ThermoFisher
ii) Wavelength: 532 nm

Through FIG. 5, the 522 cm-1 peaks corresponding to c-Si in Examples 1 to 3 and the 475 cm-1 peak corresponding to a-Si in Comparative Example 1 were confirmed. That is, it was confirmed that crystalline silicon was manufactured through Examples of the present disclosure.

### Experimental Example 3: ²⁹Si-MAS-NMR Analysis

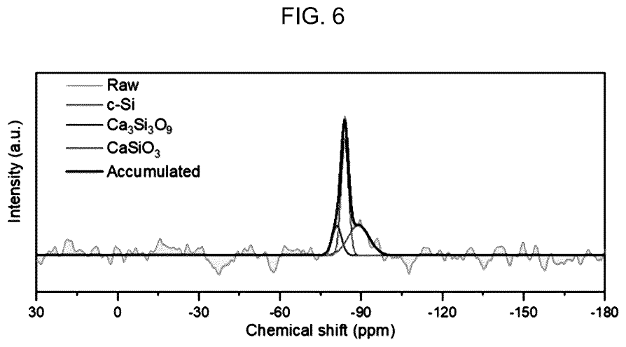

As described above, the anode active material prepared according to Example 1 was measured using a 500 MHz Avance III HD Bruker solid-state NMR system under the conditions of a rotation speed of 7 kHz, a pulse length of 45 μs, and a recycle delay of 30 seconds, and the peak area was calculated, and the results were illustrated in FIG. 6 and Table 1, respectively.

TABLE 1

| | Area | Content (%) |
|---|---|---|
| c-Si | 32337.59 | 48.6 |
| Ca₃Si₃O₉ | 10444.96 | 15.7 |
| CaSiO₃ | 23803.92 | 35.7 |

Through FIG. 6, it was confirmed that peaks corresponding to c-Si, Ca₃Si₃O₉, and CaSiO₃ appeared. In addition, as a result of calculating the peak area, it was confirmed that each phase was comprised in the same content as in Table 1 above.

### Experimental Example 4: Measurement of Internal Pores

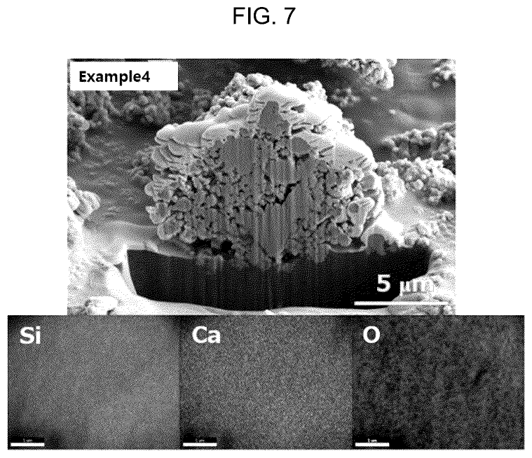

As described above, the cross-section of the anode active material prepared according to Example 4 was analyzed by FIB-SEM, and the result was shown in FIG. 7. Through FIG. 7, it was confirmed that pores were formed inside the anode active material by ball milling, and it was confirmed that Si, Ca, and O signals existed uniformly therein.

The specific FIB-SEM analysis measurement conditions were as follows.
i) Equipment: SEM (Helios G5 UC, FEI) and EDS equipment, CP-SEM (Quanta 3D, FEI)

In addition, the sizes of the internal pores of the anode active materials prepared according to Examples 1 and 4 were analyzed according to the standard measurement method of ASTM D4222 using a surface area analyzer (3Flex, Micromeritics), and the results were shown in Table 2 below.

TABLE 2

| | Pore volume (cm³/kg) |
|---|---|
| Example 1 | 7.94 |
| Example 4 | 16.75 |

As may be seen in Table 2, it was confirmed that the sizes of the internal pores increased by about twice or more after ball milling.

### Experimental Example 5: Evaluation of Initial Efficiency and Life Characteristics

Electrochemical evaluation was conducted on the anode active materials prepared according to Examples and Comparative Examples as described above.

Specifically, a slurry composition was prepared by mixing the prepared anode active material, Super-C as a conductive agent, and PAA as a binder with DI water at a mass ratio of 8:1:1. The composition was applied to a copper foil and vacuum dried at 120° C. for 6 hours to manufacture an anode.

After using lithium metal as a counter electrode and interposing a polyethylene separator between the anode and the counter electrode, a CR2032 coin cell was assembled by injecting an electrolyte mixed with 1M LiPF6 EC:EMC:DEM (25:45:30) and additives VC 1 wt %, LiPO2F₂ 2 wt %, and FEC 5 wt %. The assembled coin cell was paused at room temperature for 12 hours and then charged and discharged.

The manufactured half cell was subjected to a formation step three times at room temperature (25° C.). After charging constant current at current of 0.1C until a voltage reached 0.01 V (vs. Li⁺/Li), constant voltage was charged by cutting off at current of 0.02C while maintaining 0.01 V (vs. Lit/Li) in a constant voltage mode. Discharging was performed at constant current of 0.1C until the voltage reached 1.5 V (vs. Li⁺/Li).

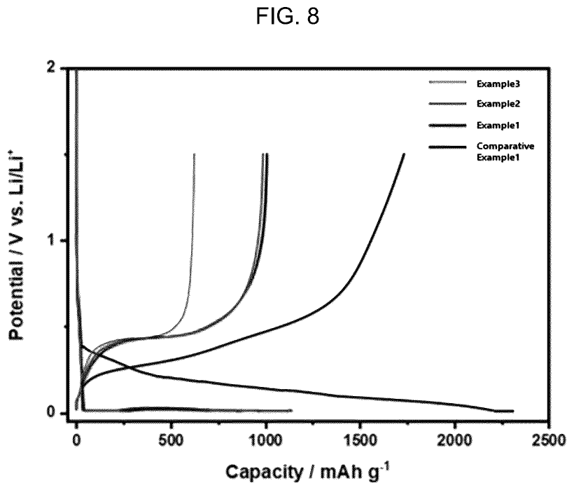

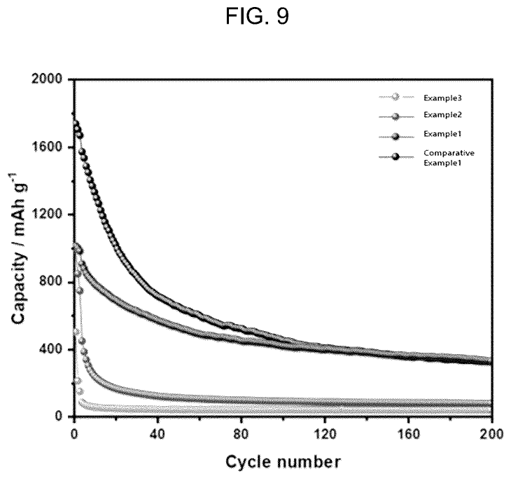

Thereafter, after charging constant current at current of 0.2C until the voltage reached 0.01 V (vs. Li⁺/Li), constant voltage charging was performed by cutting off at current of 0.02C while maintaining 0.01 V (vs. Li⁺/Li) in a constant voltage mode. Discharging was performed at constant current of 0.5C until the voltage reached 1.5 V (vs. Li⁺/Li), and the results were illustrated in FIGS. 8 and 9.

As may be seen in FIG. 8, it was confirmed that the initial efficiency increased in Examples 1 and 2. As may be seen in FIG. 9, it was confirmed that the discharge capacity of Example 1 increased compared to Comparative Example 1 based on 200 cycles.

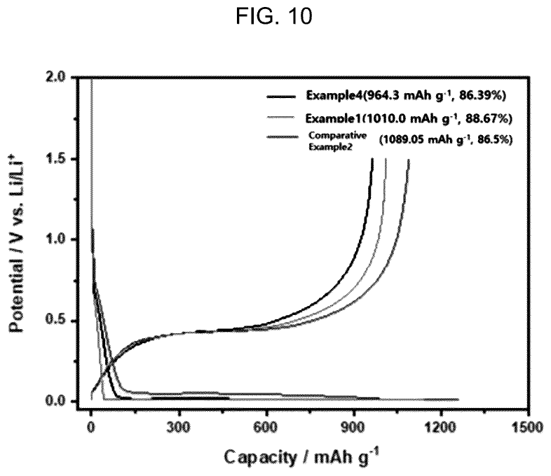

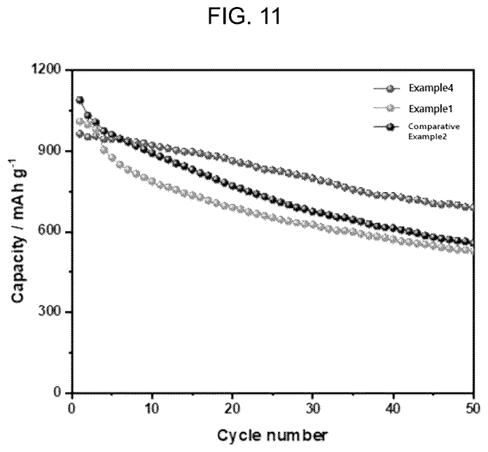

Next, the electrochemical characteristics of Examples 1 and 4, and Comparative Example 2 were evaluated, and the results were illustrated in FIGS. 10 and 11.

As may be seen in FIG. 10, it was confirmed that the discharge capacity and initial efficiency of Example 4 slightly decreased compared to Example 1. However, as may be seen in FIG. 11, it was confirmed that Example 4 showed the best life characteristics.

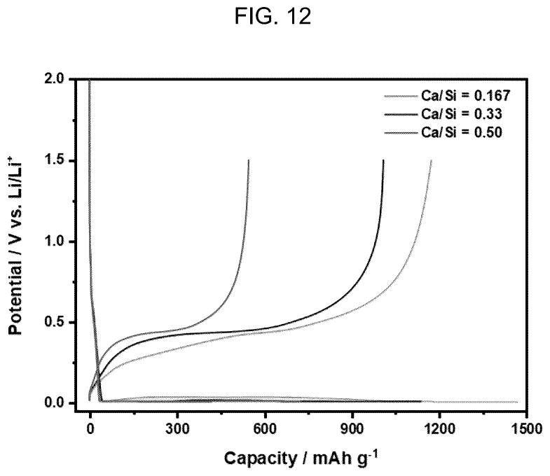

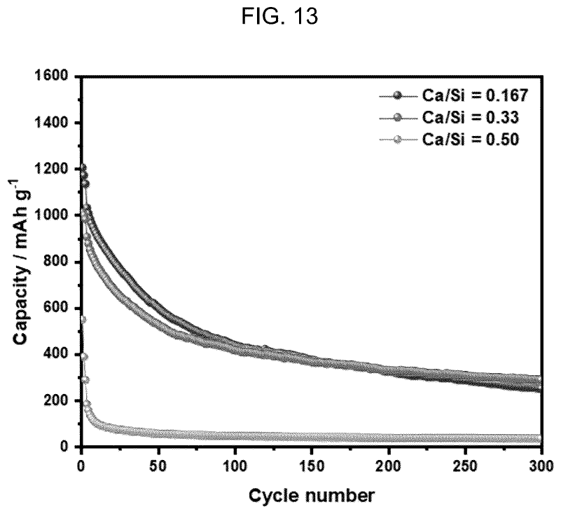

In addition, the electrochemical characteristics of Examples 1, 5, and 6 were evaluated, and the results were illustrated in FIGS. 12 and 13, and as a result, the influence of the Ca/Si molar ratio was confirmed.

As may be seen in FIG. 12, the discharge capacity decreased as the Ca/Si molar ratio increased. As may be seen in FIG. 13, it was confirmed that the life characteristics were the best when the Ca/Si molar ratio was 0.33 based on 300 cycles.

### Experimental Example 6: STEM-EDS Analysis

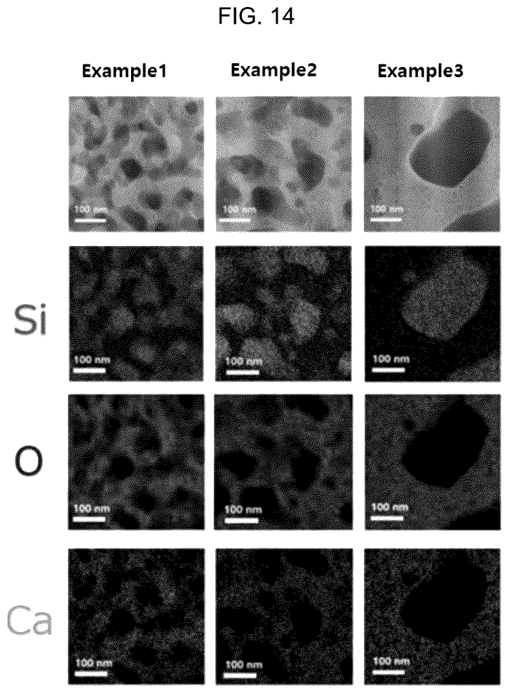

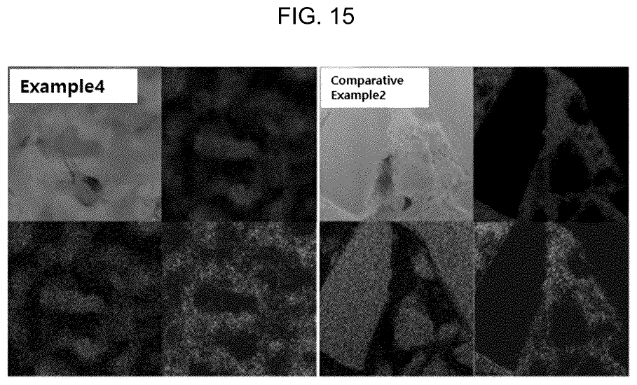

As described above, the anode active materials prepared according to the Examples and Comparative Examples were analyzed by STEM-EDS using JEOL ARM300, equipment equipped with a Cs corrector (Cs-STEM), and the results were illustrated in FIGS. 14 and 15.

The specific STEM-EDS analysis measurement conditions were as follows.
i) Equipment: JEM-2000EXII, JEOL and EDS equipment
ii) Specimen preparation: FIB, Helios G5 UC, FEI

Through FIG. 14, the regions of Si and Ca—Si—O phases were confirmed, and it was confirmed that the size of the silicon region was coarsened as the heat-treatment temperature increased. As a result, it may be expected that the life characteristics of the battery will deteriorate if an appropriate heat-treatment temperature range is exceeded.

Also, through FIG. 15, the regions of Si and Ca—Si—O phases were confirmed for Example 4 and Comparative Example 2, and the size of the silicon region of Comparative Example 2 was confirmed to be larger than that of Example 4.

### Experimental Example 7: HR-TEM Analysis

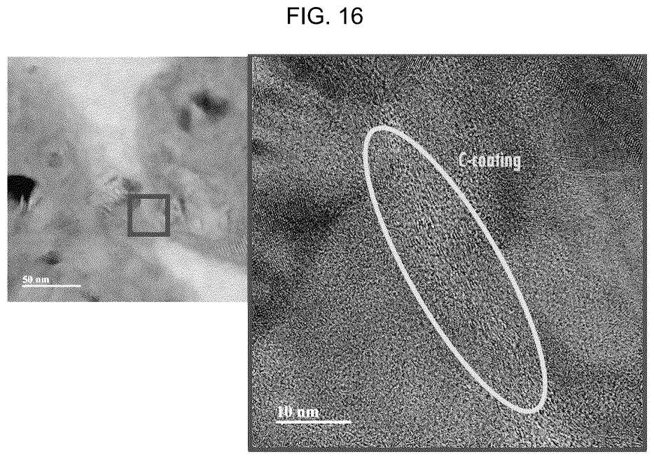

As described above, HR-TEM analysis was performed on the anode active material prepared according to Example 4, and the results were illustrated in FIG. 16.

The specific HR-TEM analysis measurement conditions were as follows.
i) Equipment: JEM-2000EXII, JEOL and EDS equipment
ii) Specimen preparation: FIB, Helios G5 UC, FEI

Through FIG. 16, it was confirmed that carbon coating of about 2 to 3 nm thickness was formed between the particles.

Features, structures, effects, and the like described in the above-described examples are comprised in at least one example of the present disclosure, and are not necessarily limited to one example. Furthermore, the features, structures, effects, and the like illustrated in each example may be combined or modified even in other examples by those of ordinary skill in the art to which the examples pertain. Accordingly, the contents related to these combinations and modifications should be interpreted to cover the scope of the present disclosure.

1. An anode active material for a rechargeable lithium battery comprising:
calcium silicate represented by CaₓSi_{y}O_{z} (1≤x≤3, 1≤y≤3, 3≤z≤9); and crystalline silicon.

2. The anode active material for the rechargeable lithium battery of claim 1,
wherein the calcium silicate comprises at least one selected from the group consisting of CaSiO₃, Ca₃Si₃O₉, and Ca₂SiO₄.

3. The anode active material for the rechargeable lithium battery of claim 1, wherein a pore volume measured by a BJH method is 5 cm³/kg to 30 cm³/kg.

4. The anode active material for the rechargeable lithium battery of claim 1, wherein the calcium silicate and the crystalline silicon are comprised in a weight ratio of 1:0.5 to 1:1.5.

5. The anode active material for the rechargeable lithium battery of claim 4, wherein the calcium silicate comprises CaSiO₃ and Ca₃Si₃O₉ in a weight ratio of 1:0.1 to 1:1.

6. The anode active material for the rechargeable lithium battery of claim 1, wherein the anode active material for the rechargeable lithium battery comprises crystalline silicon, CaSiO₃, and Ca₃Si₃O₉, and
based on 100 parts by weight of the anode active material for the rechargeable lithium battery,
the crystalline silicon is comprised in an amount of 40 to 55 parts by weight,
the CaSiO₃ is comprised in an amount of 30 to 40 parts by weight, and
the Ca₃Si₃O₉ is comprised in an amount of 10 to 20 parts by weight.

7. The anode active material for the rechargeable lithium battery of claim 1, wherein the anode active material comprises a composite combined with calcium silicate and crystalline silicon; and a carbon coating formed on at least a portion of the surface of the composite.

8. The anode active material for the rechargeable lithium battery of claim 7, wherein the anode active material has a core-shell structure comprising, a core comprising a composite combined with calcium silicate and crystalline silicon; and a shell comprising carbon.

9. The anode active material for the rechargeable lithium battery of claim 7, wherein the thickness of the carbon coating is 0.1 nm to 10 nm.

10. A method for preparing an anode active material for a rechargeable lithium battery, comprising:
a) mixing silicon monoxide (SiO) and calcium hydride (CaH₂) to prepare mixed powder; and
b) heat-treating the mixed powder to obtain a heat-treated product.

11. The method for preparing the anode active material for the rechargeable lithium battery of claim 10, wherein the mixed powder has a molar ratio (Ca/Si) of calcium to silicon of 0.1 to 1.

12. The method for preparing the anode active material for the rechargeable lithium battery of claim 10, wherein the heat treatment is performed at 800° C. to 1300° C.

13. The method for preparing the anode active material for the rechargeable lithium battery of claim 10, further comprising:
c) pulverizing the heat-treated product; and
d) carbon-coating the heat-treated product pulverized in the pulverizing step.

14. The method for preparing the anode active material for the rechargeable lithium battery of claim 13, wherein the pulverization is performed by a ball mill method.

15. The method for preparing the anode active material for the rechargeable lithium battery of claim 14, wherein the ball mill method has a Ball-to-Powder weight Ratio (BPR) of 5:1 to 50:1 and is performed for 10 hours to 36 hours.

16. The method for preparing the anode active material for the rechargeable lithium battery of claim 13, wherein the carbon coating is performed under an argon (Ar) gas atmosphere at 350° C. to 1200° C. for 0.5 hour to 10 hours.

17. An anode for a rechargeable lithium battery, comprising the anode active material for the rechargeable lithium battery of claim 1.
